(19) United States
(12) Patent Application Publication
(10) Pub. No.: US 2023/0127161 A1
(43) Pub. Date: Apr. 27, 2023

(54) IMAGE RECOGNITION SYSTEM, IMAGE RECOGNITION METHOD, AND LEARNING DEVICE

(71) Applicant: FUJITSU LIMITED, Kawasaki-shi (JP)

(72) Inventor: Xuying LEI, Kawasaki (JP)

(73) Assignee: FUJITSU LIMITED, Kawasaki-shi (JP)

(21) Appl. No.: 17/881,052

(22) Filed: Aug. 4, 2022

(30) Foreign Application Priority Data
Oct. 25, 2021 (JP) 2021-173710

(51) Int. Cl. G06V 10/77; G06V 10/22

(52) U.S. Cl. CPC G06V 10/7715; G06V 10/22

(57) ABSTRACT

An image recognition system includes at least a memory, and at least a processor coupled to at least the memory, respectively, and configured to extract feature maps from an input image, compress the extracted feature maps, reconstruct the compressed feature maps, reconstruct an image from the reconstructed feature maps and output the reconstructed image, and recognize the input image based on the reconstructed feature maps and output a recognition result, wherein the compressing the extracted feature maps and the reconstructing the compressed feature maps are learned so as to minimize a cost based on an information amount when compressing the extracted feature maps, a first error between the input image and the reconstructed image, and a second error between the recognition result and a ground truth.

### CROSS-REFERENCE TO RELATED APPLICATION

This application is based upon and claims the benefit of priority of the prior Japanese Patent Application No. 2021-173710, filed on Oct. 25, 2021, the entire contents of which are incorporated herein by reference.

### FIELD

The embodiments discussed herein are related to an image recognition system, an image recognition method, and a learning device.

### BACKGROUND

Typically, when image data is transmitted, a transmission cost is reduced by reducing a data size through compression processing. There are various image data compression processing methods, for example, in compression processing through deep learning using an autoencoder, the compression processing is executed so as to maintain an image quality before transmission when the image data is reconstructed in a transmission destination.

On the other hand, in a case where the image data is transmitted to be used for recognition processing by artificial intelligence (AI), feature maps needed for the recognition processing is extracted from the image data so as to maintain recognition accuracy at the transmission destination, and compression processing is executed on the extracted feature maps.

Japanese Laid-open Patent Publication No. 2020-201944 and Japanese Laid-open Patent Publication No. 2020-68014 are disclosed as related art.

### SUMMARY

According to an aspect of the embodiments, an image recognition system includes at least a memory, and at least a processor coupled to at least the memory, respectively, and configured to extract feature maps from an input image, compress the extracted feature maps, reconstruct the compressed feature maps, reconstruct an image from the reconstructed feature maps and output the reconstructed image, and recognize the input image based on the reconstructed feature maps and output a recognition result, wherein the compressing the extracted feature maps and the reconstructing the compressed feature maps are learned so as to minimize a cost based on an information amount when compressing the extracted feature maps, a first error between the input image and the reconstructed image, and a second error between the recognition result and a ground truth.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating an example of a system configuration of an image recognition system;

FIGS. 2A and 2B are diagrams illustrating an example of hardware configurations of an image processing device and an image recognition device;

FIG. 3 is a first diagram illustrating an example of a functional configuration of the image processing device in a learning phase;

FIG. 4 is a first diagram illustrating a method for generating each unit of a learning unit;

FIG. 5 is a second diagram illustrating the method for generating each unit of the learning unit;

FIG. 6 is a first flowchart illustrating a flow of processing in the learning phase;

FIG. 7 is a first flowchart illustrating a flow of learning processing;

FIG. 8 is a first diagram illustrating an example of functional configurations of the image processing device and the image recognition device in an inference phase;

FIG. 9 is a flowchart illustrating a flow of compression/reconstruction/recognition processing;

FIG. 10 is a second diagram illustrating an example of the functional configuration of the image processing device in the learning phase;

FIG. 11 is a second diagram illustrating an example of the functional configurations of the image processing device and the image recognition device in the inference phase;

FIG. 12 is a third diagram illustrating an example of the functional configuration of the image processing device in the learning phase;

FIG. 13 is a second flowchart illustrating the flow of the processing in the learning phase;

FIG. 14 is a third diagram illustrating an example of the functional configurations of the image processing device and the image recognition device in the inference phase;

FIG. 15 is a first diagram illustrating an example of reconstructed image data;

FIG. 16 is a fourth diagram illustrating an example of the functional configuration of the image processing device in the learning phase;

FIG. 17 is a second flowchart illustrating the flow of the learning processing; and

FIGS. 18A and 18B are second diagrams illustrating an example of the reconstructed image data.

### DESCRIPTION OF EMBODIMENTS

There are various methods for using image data in a transmission destination, and for example, in a case where a person visually confirms a result of recognition processing by the AI, it is requested to maintain both of an image quality and recognition accuracy.

Hereinafter, embodiments of a technology for executing compression processing so as to maintain both of an image quality and recognition accuracy in a transmission destination of image data will be described with reference to the attached drawings. Note that, in the present specification and the drawings, components having substantially the same functional configuration are denoted with the same reference numeral, and redundant description will be omitted.

### First Embodiment

[System Configuration of Image Recognition System]

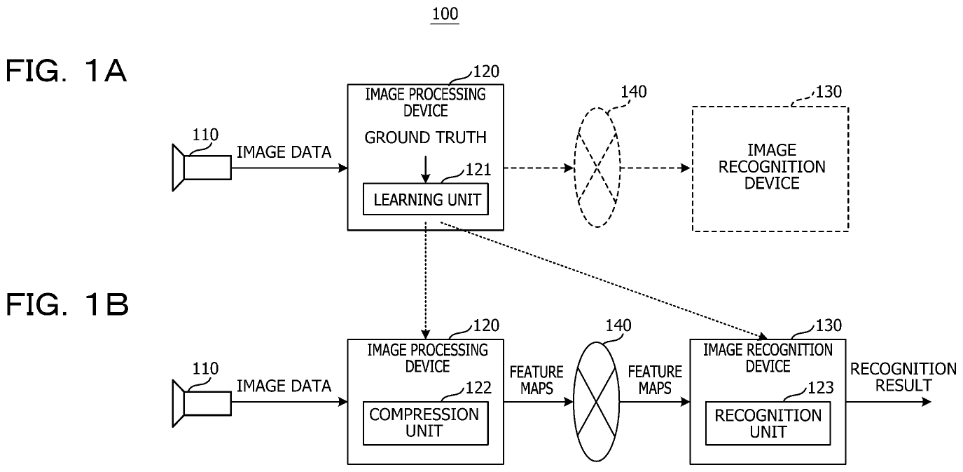

First, a system configuration of an image recognition system according to a first embodiment will be described. FIGS. 1A and 1B are diagrams illustrating an example of the system configuration of the image recognition system. An image recognition system 100 according to the present embodiment is roughly divided into a system configuration in a learning phase and a system configuration in an inference phase.

FIG. 1A illustrates the system configuration of the image recognition system in the learning phase, and FIG. 1B illustrates the system configuration of the image recognition system in the inference phase.

As illustrated in FIG. 1A, the image recognition system 100 in the learning phase includes an imaging device 110 and an image processing device 120.

The imaging device 110 captures an image at a predetermined frame period, and transmits image data to the image processing device 120. Note that the image data includes an object to be recognized.

An image processing program is installed in the image processing device 120, and a learning program included in the image processing program is executed in the learning phase. As a result, the image processing device 120 in the learning phase functions as a learning unit 121 (learning device).

The learning unit 121 has a function for extracting-feature maps from image data, a function for compressing the extracted feature maps, a function for reconstructing the compressed feature maps, a function for reconstructing image data from the reconstructed feature maps, and a function of recognizing the image data on the basis of the reconstructed feature maps. Furthermore, the learning unit 121 executes learning processing, using the ground truth, for—the function for compressing the feature maps extracted from image data before being transmitted so as to maintain both of an image quality and recognition accuracy for image data reconstructed in a transmission destination and—the function for reconstructing the compressed feature maps.

On the other hand, as illustrated in FIG. 1B, the image recognition system 100 in the inference phase includes an imaging device 110, an image processing device 120, and an image recognition device 130. Furthermore, the image processing device 120 and the image recognition device 130 are communicably connected to each other via a network 140. Note that, among the devices included in the image recognition system 100 in the inference phase, the imaging device 110 has already been described, and thus the description thereof will be omitted here.

On the other hand, as described above, an image processing program is installed in the image processing device 120, and a compression program included in the image processing program is executed in the inference phase. As a result, the image processing device 120 in the inference phase functions as a compression unit 122.

The compression unit 122 has a function for extracting feature maps from image data and a function for compressing the extracted feature maps. Note that, as described above, for the function for compressing the feature maps extracted from the image data before being transmitted, learning processing is executed so as to maintain both of the image quality and the recognition accuracy for the image data reconstructed in the transmission destination.

Furthermore, the compression unit 122 transmits the compressed feature amount to the image recognition device 130 via the network 140.

A recognition program is installed in the image recognition device 130, and execution of the recognition program causes the image recognition device 130 to function as a recognition unit 123.

The recognition unit 123 has a function for reconstructing a compressed feature amount, a function for reconstructing image data from the reconstructed feature maps, and a function for recognizing image data on the basis of the reconstructed feature maps. Note that, as described above, on the function for reconstructing the compressed feature maps, learning processing is executed so as to maintain both of the image quality and the recognition accuracy.

In this way, the image processing device 120 compresses and transmits the feature maps so as to maintain both of the image quality and the recognition accuracy of the image data reconstructed in the transmission destination. As a result, the image recognition device 130 in the transmission destination reconstructs the image data that maintains the image quality and maintains the recognition accuracy in image data recognition processing on the basis of the feature maps.

[Hardware Configurations of Image Processing Device and Image Recognition Device]

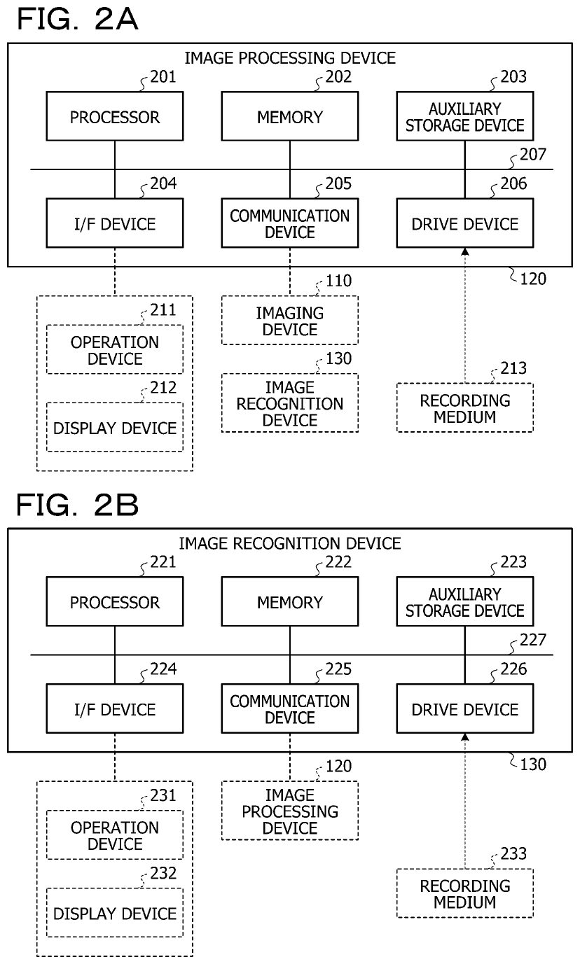

Next, hardware configurations of the image processing device 120 and the image recognition device 130 will be described. FIGS. 2A and 2B are diagrams illustrating an example of the hardware configurations of the image processing device and the image recognition device.

(1) Hardware Configuration of Image Processing Device

Of these, FIG. 2A is a diagram illustrating an example of the hardware configuration of the image processing device. As illustrated in FIG. 2A, the image processing device 120 includes a processor 201, a memory 202, an auxiliary storage device 203, an interface (I/F) device 204, a communication device 205, and a drive device 206. Note that the pieces of the hardware of the image processing device 120 are connected to each other via a bus 207.

The processor 201 includes various arithmetic devices such as a central processing unit (CPU) or a graphics processing unit (GPU). The processor 201 reads various programs (for example, learning program in learning phase, compression program in inference phase, or the like) on the memory 202 and executes the programs.

The memory 202 includes a main storage device such as a read only memory (ROM) or a random access memory (RAM). The processor 201 and the memory 202 form a so-called computer. The processor 201 executes various programs read into the memory 202 to cause the computer to implement various functions described above.

The auxiliary storage device 203 stores various programs and various types of data used when various programs are executed by the processor 201.

The I/F device 204 is a connection device that connects an external device (operation device 211 and display device 212 in learning phase) to the image processing device 120. The I/F device 204 receives an operation on the image processing device 120 via the operation device 211 in the learning phase. Furthermore, the I/F device 204 outputs a result of processing by the image processing device 120 in the learning phase and displays the result via the display device 212.

The communication device 205 is a communication device for communicating with another device in the image recognition system 100. For example, the communication device 205 communicates with the imaging device 110 in the learning phase and communicates with the imaging device 110 and the image recognition device 130 in the inference phase.

The drive device 206 is a device used to set a recording medium 213. The recording medium 213 here includes a medium that optically, electrically, or magnetically records information, such as a compact disc read only memory (CD-ROM), a flexible disk, or a magneto-optical disk. Furthermore, the recording medium 213 may include a semiconductor memory or the like that electrically records information, such as a ROM or a flash memory.

Note that various programs to be installed in the auxiliary storage device 203 are installed, for example, by setting the distributed recording medium 213 in the drive device 206 and reading the various programs recorded in the recording medium 213 by the drive device 206. Alternatively, the various programs installed in the auxiliary storage device 203 may be installed by being downloaded from the network 140 via the communication device 205.

(2) Hardware Configuration of Image Recognition Device

Next, the hardware configuration of the image recognition device 130 will be described. FIG. 2B is a diagram illustrating an example of the hardware configuration of the image recognition device. Note that, because the hardware configuration of the image recognition device 130 is substantially the same as the hardware configuration of the image processing device 120, differences will be mainly described here.

For example, a processor 221 reads a recognition program or the like on a memory 222 and executes the recognition program. A communication device 225 communicates with the image processing device 120 via the network 140.

[Functional Configuration of Image Processing Device in Learning Phase]

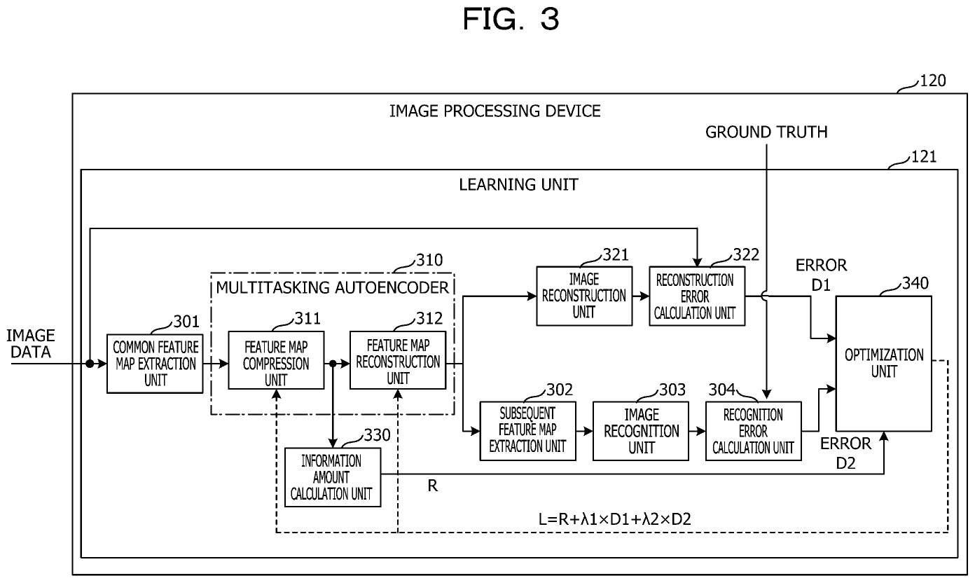

Next, a functional configuration of the image processing device 120 in the learning phase will be described. FIG. 3 is a first diagram illustrating an example of the functional configuration of the image processing device in the learning phase. As described above, the image processing device 120 functions as the learning unit 121 in the learning phase.

As illustrated in FIG. 3, the learning unit 121 includes a common feature map extraction unit 301 and a multitasking autoencoder 310. Furthermore, the learning unit 121 includes an image reconstruction unit 321, a reconstruction error calculation unit 322, a subsequent feature map extraction unit 302, an image recognition unit 303, a recognition error calculation unit 304, an information amount calculation unit 330, and an optimization unit 340.

The common feature map extraction unit 301 is an example of an extraction unit and is a deep neural network (DNN)-based compressor that compresses image data. Note that the DNN-based compressor that compresses image data has a similar network structure to a convolutional neural network (CNN)-based feature map extraction block used to recognize image data. Therefore, the compressor extracts features related to a task for recognizing image data in principle. Therefore, in the present embodiment, the common feature map extraction unit 301 is caused to function as the compressor and is caused to function as the CNN-based feature map extraction block used to recognize image data, so as to extract a feature map from the image data. As an example, the common feature map extraction unit 301 is caused to function as a feature map extraction block in a first layer of the CNN that recognizes the image data.

The common feature map extraction unit 301 inputs the feature map extracted from the image data into the multitasking autoencoder 310. Note that details of a method for generating the common feature map extraction unit 301 will be described later.

The multitasking autoencoder 310 includes a feature map compression unit 311 and a feature map reconstruction unit 312. In a case where the feature map extracted by the common feature map extraction unit 301 is input, the feature map compression unit 311 compresses the extracted feature map.

The feature map reconstruction unit 312 reconstructs the feature map compressed by the feature map compression unit 311 and notifies the image reconstruction unit 321 and the subsequent feature map extraction unit 302.

Note that, when the learning processing by the learning unit 121 is executed, model parameters of the feature map compression unit 311 and the feature map reconstruction unit 312 are appropriately updated so as to maintain both of an image quality and recognition accuracy of the reconstructed image data.

In a case where the reconstructed feature map is notified by the feature map reconstruction unit 312, the image reconstruction unit 321 reconstructs image data on the basis of the reconstructed feature map. Furthermore, the image reconstruction unit 321 notifies the reconstruction error calculation unit 322 of the reconstructed image data.

The reconstruction error calculation unit 322 compares the image data input to the common feature map extraction unit 301 and the reconstructed image data notified by the image reconstruction unit 321 and calculates an error (deterioration in image quality). Furthermore, the reconstruction error calculation unit 322 notifies the optimization unit 340 of the calculated error (D1).

Note that any method for calculating the error (D1) by the reconstruction error calculation unit 322 may be used, and for example, peak signal to noise ratio (PSNR), structural similarity index measure (SSIM), or the like are exemplified. Of these, the PSNR is an index defined on the basis of perceptual sensitivity of a noise component generated by the compression processing. On the other hand, the SSIM is an index defined as assuming that a similarity of an image structure contributes to human perception of image quality deterioration.

In a case where the reconstructed feature map is notified by the feature map reconstruction unit 312, the subsequent feature map extraction unit 302 further extracts a feature map used to recognize the image data from the reconstructed feature map. For example, the subsequent feature map extraction unit 302 is formed by a feature map extraction block in and subsequent to a second layer of the CNN that recognizes the image data. The reconstructed feature map notified by the feature map reconstruction unit 312 is substantially the same as the feature map extracted by the feature map extraction block in the first layer of the CNN. For example, the CNN used to recognize the image data is formed by the common feature map extraction unit 301 and the subsequent feature map extraction unit 302.

The image recognition unit 303 corresponds to a fully connected unit connected to the CNN. The image recognition unit 303 recognizes image data by fully connecting the feature map extracted by the subsequent feature map extraction unit 302. Furthermore, the image recognition unit 303 notifies the recognition error calculation unit 304 of a recognition result obtained by recognizing the image data. Note that the subsequent feature map extraction unit 302 and the image recognition unit 303 are examples of a recognition unit, and details of a generation method thereof will be described later.

The recognition error calculation unit 304 compares the recognition result notified by the image recognition unit 303 and the ground truth regarding a recognition target included in the image data input to the common feature map extraction unit 301 and calculates an error (recognition error). Furthermore, the recognition error calculation unit 304 notifies the optimization unit 340 of the calculated error (D2).

Note that any method for calculating the error (D2) by the recognition error calculation unit 304 may be used, and for example, square sum error (SSE), cross entropy, or the like are exemplified.

The information amount calculation unit 330 calculates a probability distribution of the feature map compressed by the feature map compression unit 311 and calculates an information entropy (R) of the probability distribution. Furthermore, the information amount calculation unit 330 notifies the optimization unit 340 of the calculated information entropy (R).

Note that, any method for calculating the information entropy by the information amount calculation unit 330 may be used, and for example, Gaussian mixture model (GMM) may be used as a probability model.

The optimization unit 340 weights and adds the error (D1) notified by the reconstruction error calculation unit 322 and the error (D2) notified by the recognition error calculation unit 304. Moreover, the optimization unit 340 calculates a cost (L) by adding the information entropy (R) notified by the information amount calculation unit 330 to the weighted and added result (refer to the following formula 1).

cost(L)=R+λ1×D1+λ2×D2 (Formula 1)

However, λ1 and λ2 are arbitrary weighting coefficients.

The learning unit 121 updates the model parameters of the feature map compression unit 311 and the feature map reconstruction unit 312 so as to minimize the cost (L) calculated by the optimization unit 340 at the time of the learning processing.

At this time, by setting a value of λ1 to be larger and executing the learning processing, the model parameters of the multitasking autoencoder 310 (feature map compression unit 311 and feature map reconstruction unit 312) are updated so as to prioritize maintenance of the image quality. Furthermore, by setting a value of λ2 to be larger and executing the learning processing, the model parameters of the multitasking autoencoder 310 (feature map compression unit 311 and feature map reconstruction unit 312) are updated so as to prioritize maintenance of the recognition accuracy.

[Details of Method for Generating Each Unit of Learning Unit]

Next, details of the method for generating each unit (here, common feature map extraction unit 301, image reconstruction unit 321, subsequent feature map extraction unit 302, and image recognition unit 303) of the learning unit 121 will be described.

(1) Method for Generating the Common Feature Map Extraction Unit 301 and the Image Reconstruction Unit 321

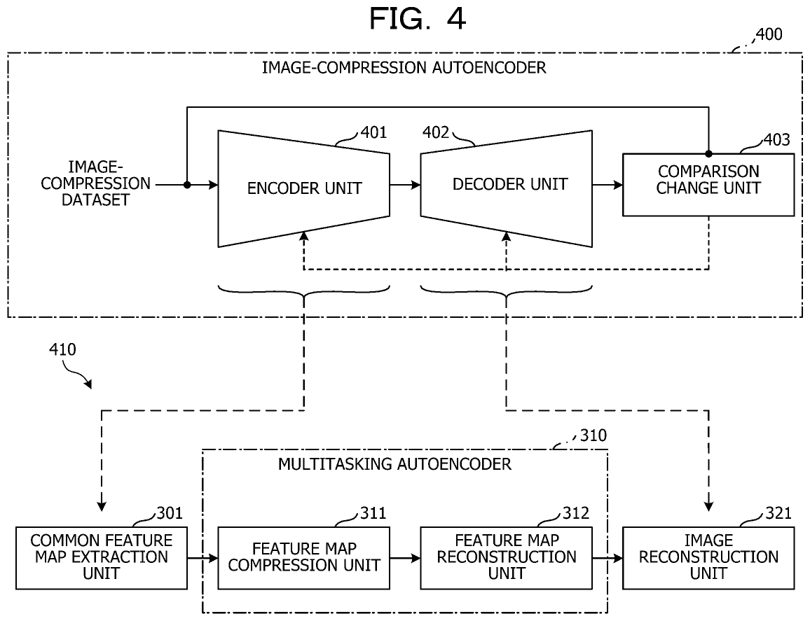

First, the details of the method for generating the common feature map extraction unit 301 and the image reconstruction unit 321 will be described. FIG. 4 is a first diagram illustrating a method for generating each unit of the learning unit.

In FIG. 4, an image-compression autoencoder 400 is an autoencoder for generating the common feature map extraction unit 301 and the image reconstruction unit 321. As illustrated in FIG. 4, the image-compression autoencoder 400 includes an encoder unit 401, a decoder unit 402, and a comparison change unit 403.

Image data included in an image-compression dataset is sequentially input to the encoder unit 401. The encoder unit 401 compresses the input image data and outputs the compressed image data.

The decoder unit 402 reconstructs the image data compressed by the encoder unit 401 and outputs the reconstructed image data.

The comparison change unit 403 compares the image data input to the encoder unit 401 and the reconstructed image data output by the decoder unit 402 and calculates an error (deterioration in image quality). Furthermore, the comparison change unit 403 updates model parameters of the encoder unit 401 and the decoder unit 402 on the basis of the calculated error.

As a result, the image-compression autoencoder 400 generates the learned encoder unit 401 and the learned decoder unit 402 using the image-compression dataset.

On the other hand, in FIG. 4, a reference numeral 410 excerpts and indicates a part of the units included in the learning unit 121 illustrated in FIG. 3. As illustrated in FIG. 4, the learned encoder unit 401 generated using the image-compression dataset is used as the common feature map extraction unit 301 of the learning unit 121. Furthermore, the learned decoder unit 402 generated using the image-compression dataset is used as the image reconstruction unit 321 of the learning unit 121.

In this way, in the present embodiment, the common feature map extraction unit 301 and the image reconstruction unit 321 of the learning unit 121 are generated by the image-compression autoencoder 400.

(2) Method for Generating the Subsequent Feature Map Extraction Unit 302 and the Image Recognition Unit 303

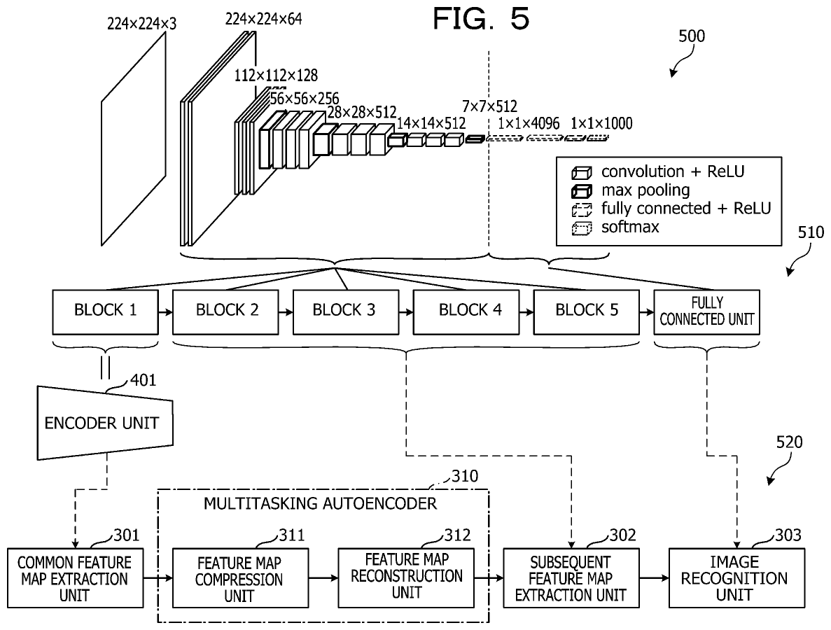

Next, the details of the method for generating the subsequent feature map extraction unit 302 and the image recognition unit 303 will be described. FIG. 5 is a second diagram illustrating the method for generating each unit of the learning unit.

In FIG. 5, a learned image recognition model 500 is an example of a convolutional neural network formed by 16 layers in total, including 13 convolutional layers and three fully connected layers. The learned image recognition model 500 may be divided into the CNN and the fully connected unit, and as indicated by a reference numeral 510, the CNN may be further roughly divided into five blocks including blocks 1 to 5.

In a case of the example in FIG. 5, —the block 1 is formed of (convolutional layer+ReLU layer)×3, —the block 2 is formed of the max pooling layer×1+(convolutional layer+ReLU layer)×2, —the block 3 is formed of the max pooling layer×1+(convolutional layer+ReLU layer)×3, —the block 4 is formed of the max pooling layer×1+(convolutional layer+ReLU layer)×3, and—the block 5 is formed of the max pooling layer×1+(convolutional layer+ReLU layer)×3.

Furthermore, in a case of the example in FIG. 5, —the fully connected unit is formed of (fully connected layer+ReLU)×3+softmax function.

Furthermore, in FIG. 5, a reference numeral 520 excerpts and indicates a part of the units included in the learning unit 121 illustrated in FIG. 3. As illustrated in FIG. 5, the blocks 2 to 5 of the learned image recognition model 500 are used as the subsequent feature map extraction unit 302, and the fully connected unit is used as the image recognition unit 303.

In this way, in the present embodiment, the subsequent feature map extraction unit 302 and the image recognition unit 303 of the learning unit 121 are generated by the learned image recognition model 500.

Note that, as described above, the block 1 (feature map extraction block in first layer of CNN) included in a reference numeral 510 has a network structure close to that of the encoder unit 401. Therefore, it may be said that, even in a case where the learned encoder unit 401 is caused to function as the common feature map extraction unit 301 instead of the block 1, —the common feature map extraction unit 301, the subsequent feature map extraction unit 302, and the image recognition unit 303 have recognition accuracy substantially equivalent to—the blocks 1 to 5 of the learned image recognition model 500 and the fully connected unit.

[Flow of Processing in Learning Phase]

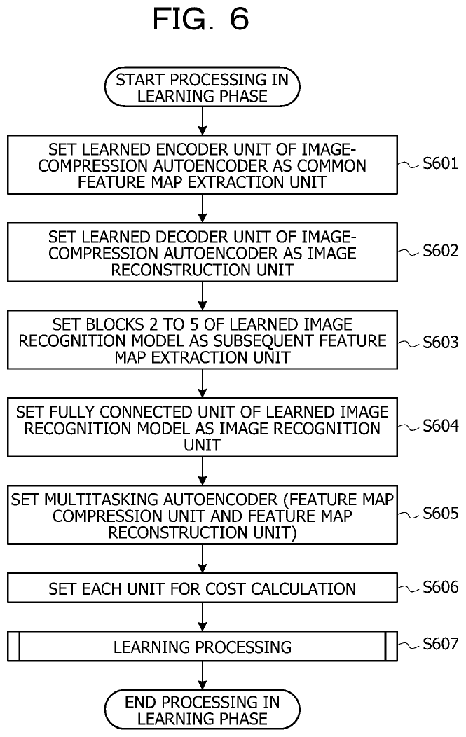

Next, a flow of processing of the entire image recognition system 100 in the learning phase will be described. FIG. 6 is a first flowchart illustrating a flow of processing in the learning phase.

In operation S601, a user of the image processing device 120 sets the learned encoder unit of the image-compression autoencoder 400 to the learning unit 121, as the common feature map extraction unit 301.

In operation S602, the user of the image processing device 120 sets the learned decoder unit of the image-compression autoencoder 400 to the learning unit 121, as the image reconstruction unit 321.

In operation S603, the user of the image processing device 120 sets the blocks 2 to 5 of the CNN of the learned image recognition model 500 to the learning unit 121, as the subsequent feature map extraction unit 302.

In operation S604, the user of the image processing device 120 sets the fully connected unit of the learned image recognition model 500 to the learning unit 121, as the image recognition unit 303.

In operation S605, the user of the image processing device 120 sets the multitasking autoencoder 310 including the encoder unit that functions as the feature map compression unit 311 and the decoder unit that functions as the feature map reconstruction unit 312 to the learning unit 121.

In operation S606, the user of the image processing device 120 sets each unit for cost calculation (reconstruction error calculation unit 322, recognition error calculation unit 304, information amount calculation unit 330, and optimization unit 340) to the learning unit 121. At this time, the user of the image processing device 120 sets the weighting coefficients (λ1 and λ2) together used to calculate costs.

In operation S607, the learning unit 121 of the image processing device 120 executes learning processing regarding the multitasking autoencoder 310 by inputting image data and the ground truth for a recognition target included in the image data. Note that details of the learning processing will be described later.

[Flow of Learning Processing]

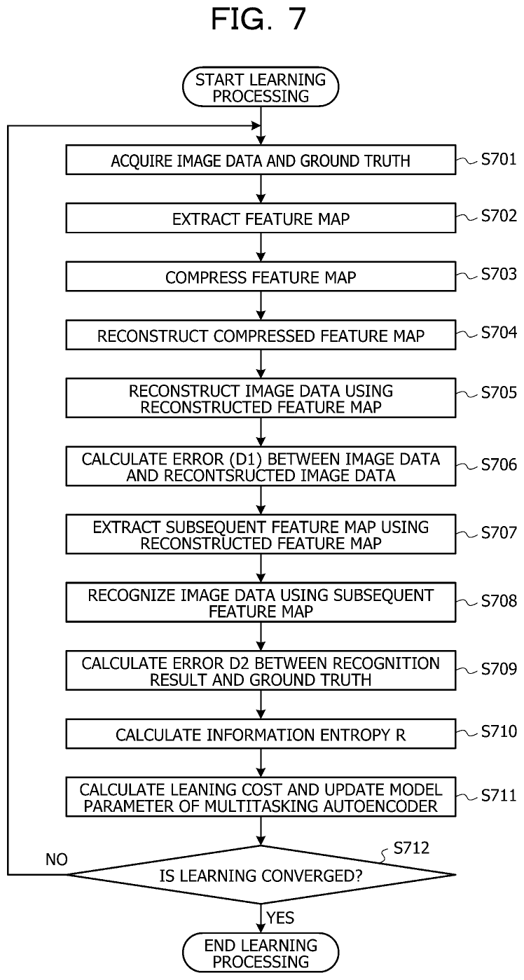

Next, the details of the learning processing (operation S607 in FIG. 6) will be described. FIG. 7 is a first flowchart illustrating a flow of the learning processing.

In operation S701, the learning unit 121 acquires image data imaged by the imaging device 110 and the ground truth for a recognition target included in the image data.

In operation S702, the common feature map extraction unit 301 of the learning unit 121 extracts a feature map from the acquired image data.

In operation S703, the feature map compression unit 311 of the learning unit 121 compresses the feature map extracted by the common feature map extraction unit 301.

In operation S704, the feature map reconstruction unit 312 of the learning unit 121 reconstructs the feature map compressed by the feature map compression unit 311.

In operation S705, the image reconstruction unit 321 of the learning unit 121 reconstructs image data using the feature map reconstructed by the feature map reconstruction unit 312.

In operation S706, the reconstruction error calculation unit 322 of the learning unit 121 compares the image data acquired by the learning unit 121 and the image data reconstructed by the image reconstruction unit 321 and calculates an error (D1).

In operation S707, the subsequent feature map extraction unit 302 of the learning unit 121 extracts a subsequent feature map on the basis of the feature map reconstructed by the feature map reconstruction unit 312.

In operation S708, the image recognition unit 303 of the learning unit 121 recognizes ta recognition target included in the image data on the basis of the subsequent feature map extracted by the subsequent feature map extraction unit 302.

In operation S709, the recognition error calculation unit 304 of the learning unit 121 compares the recognition result by the image recognition unit 303 and the ground truth acquired by the learning unit 121 and calculates an error (D2).

In operation S710, the information amount calculation unit 330 of the learning unit 121 calculates a probability distribution of the feature map extracted by the feature map compression unit 311 and calculates an information entropy (R) of the probability distribution.

In operation S711, the optimization unit 340 of the learning unit 121 weights and adds the errors (D1) and (D2) and adds the information entropy (R) so as to calculate a cost L. Furthermore, the learning unit 121 updates the model parameters of the multitasking autoencoder 310 (feature map compression unit 311 and feature map reconstruction unit 312) so as to minimize the cost L calculated by the optimization unit 340.

In operation S712, the learning unit 121 determines whether or not the learning processing is converged. In a case where it is determined in operation S712 that the learning processing is not converged (a case of No in operation S712), the procedure returns to operation S701.

On the other hand, in a case where it is determined in operation S712 that the learning processing is converged (a case of Yes in operation S712), the learning processing ends.

[Functional Configurations of Image Processing Device and Image Recognition Device in Inference Phase]

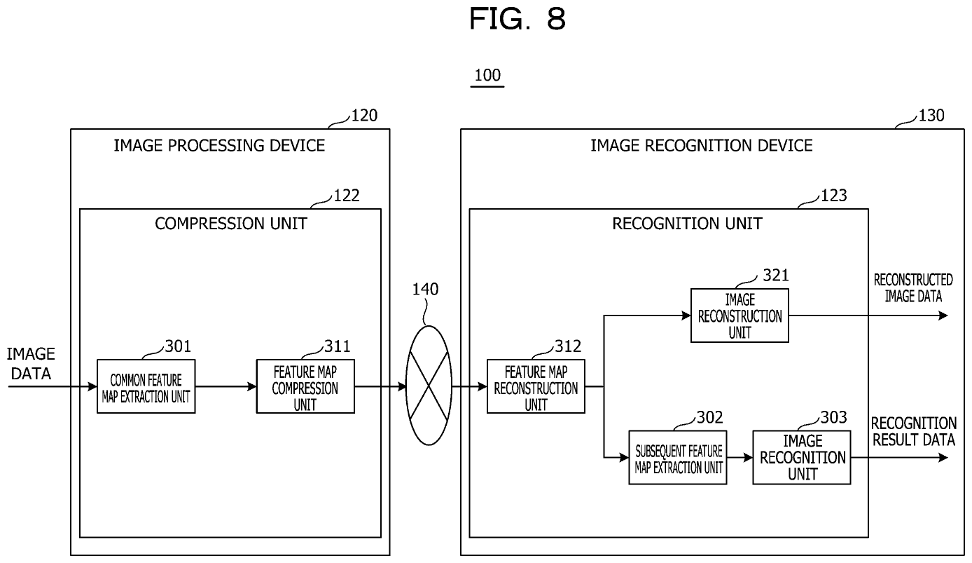

Next, functional configurations of the image processing device 120 and the image recognition device 130 in the inference phase will be described. FIG. 8 is a first diagram illustrating an example of the functional configurations of the image processing device and the image recognition device in the inference phase. As described above, in the inference phase, the image processing device 120 functions as the compression unit 122, and the image recognition unit 303 functions as the recognition unit 123.

As illustrated in FIG. 8, the compression unit 122 includes the common feature map extraction unit 301 and the feature map compression unit 311. Note that, since the common feature map extraction unit 301 has been described with reference to FIG. 3, description thereof will be omitted here.

The feature map compression unit 311 illustrated in FIG. 8 is substantially the same as the feature map compression unit 311 described with reference to FIG. 3. However, the feature map compression unit 311 illustrated in FIG. 8 is a learned feature map compression unit of which a model parameter is updated through learning processing.

Furthermore, as illustrated in FIG. 8, the recognition unit 123 includes the feature map reconstruction unit 312, the image reconstruction unit 321, the subsequent feature map extraction unit 302, and the image recognition unit 303.

The feature map reconstruction unit 312 illustrated in FIG. 8 is substantially the same as the feature map reconstruction unit 312 described with reference to FIG. 3. However, the feature map reconstruction unit 312 illustrated in FIG. 8 is a learned feature map reconstruction unit of which a model parameter is updated through the learning processing.

Since the image reconstruction unit 321, the subsequent feature map extraction unit 302, and the image recognition unit 303 have been described with reference to FIG. 3, description thereof will be omitted here.

[Flow of Compression/Reconstruction/Recognition Processing]

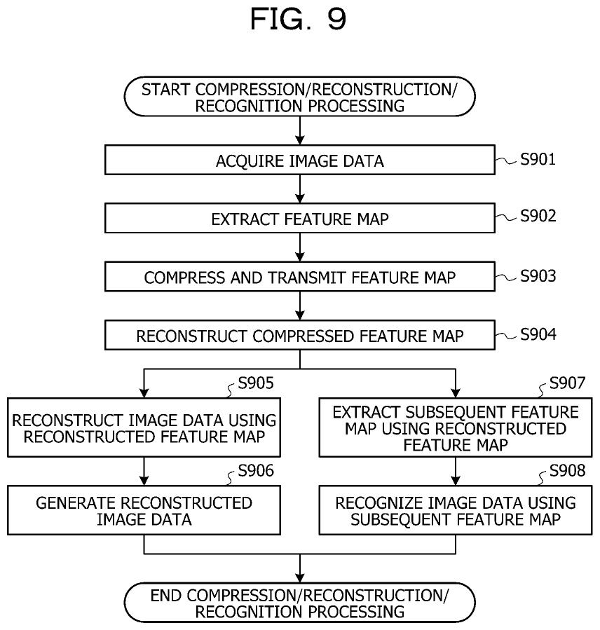

Next, a flow of compression/reconstruction/recognition processing in the inference phase will be described. FIG. 9 is a flowchart illustrating the flow of the compression/reconstruction/recognition processing.

In operation S901, the compression unit 122 of the image processing device 120 acquires image data imaged by the imaging device 110.

In operation S902, the common feature map extraction unit 301 of the compression unit 122 extracts a feature map from the acquired image data.

In operation S903, the feature map compression unit 311 of the compression unit 122 compresses the feature map extracted by the common feature map extraction unit 301 and transmits the feature map to the image recognition device 130.

In operation S904, the recognition unit 123 of the image recognition device 130 acquires the feature map compressed by the feature map compression unit 311. Furthermore, the feature map reconstruction unit 312 of the recognition unit 123 reconstructs the feature map compressed by the feature map compression unit 311.

In operation S905, the image reconstruction unit 321 of the recognition unit 123 reconstructs the image data on the basis of the feature map reconstructed by the feature map reconstruction unit 312 and generates reconstructed image data.

Furthermore, in operation S907, the subsequent feature map extraction unit 302 of the recognition unit 123 extracts a subsequent feature map on the basis of the feature map reconstructed by the feature map reconstruction unit 312.

In operation S908, the image recognition unit 303 of the recognition unit 123 recognizes a recognition target included in the image data on the basis of the subsequent feature map extracted by the subsequent feature map extraction unit 302.

As is clear from the above description, the image recognition system 100 according to the first embodiment includes the common feature map extraction unit that extracts the feature map from the input image data and the feature map compression unit that compresses the extracted feature map. Furthermore, the image recognition system 100 according to the first embodiment includes the feature map reconstruction unit that reconstructs the compressed feature map and the image reconstruction unit that reconstructs the image data from the reconstructed feature map and outputs the reconstructed image data. Furthermore, the image recognition system 100 according to the first embodiment includes the subsequent feature map extraction unit that extracts the subsequent feature map on the basis of the reconstructed feature map and the image recognition unit that recognizes the recognition target included in the image data on the basis of the extracted subsequent feature map. Then, in the image recognition system 100 according to the first embodiment, the feature map compression unit and the feature map reconstruction unit are learned so as to minimize the cost. Furthermore, the cost is calculated by weighting and adding the error between the image data and the reconstructed image data and the error between the recognition result when the recognition target is recognized and the ground truth and further adding the information entropy when the feature map is compressed by the feature map compression unit.

In this way, the image recognition system 100 executes the learning processing for the feature map compression unit and the feature map reconstruction unit so as to maintain both of the image quality and the recognition accuracy for the image data reconstructed in the transmission destination.

As a result, the image recognition device 130 in the transmission destination reconstructs the image data that maintains the image quality and maintains the recognition accuracy in image data recognition processing based on the feature map.

For example, according to the first embodiment, the compression processing may be executed so as to maintain both of the image quality and the recognition accuracy in the transmission destination of the image data.

### Second Embodiment

In the first embodiment described above, a case has been described in which the weighting coefficients (λ1 and λ2) used to calculate a cost are fixed and the learning processing is executed regarding the multitasking autoencoder 310. On the other hand, as described in the first embodiment described above, by changing the weighting coefficients (λ1 and λ2), it is possible to execute learning processing that prioritizes maintenance of an image quality and learning processing that prioritizes maintenance of recognition accuracy. For example, by changing the weighting coefficients (λ1 and λ2), it is possible to adjust priority between the image quality and the recognition accuracy. Hereinafter, in a second embodiment, an image recognition system that adjusts priorities will be described. Note that, differences from the first embodiment described above will be mainly described.

[Functional Configuration of Image Processing Device in Learning Phase]

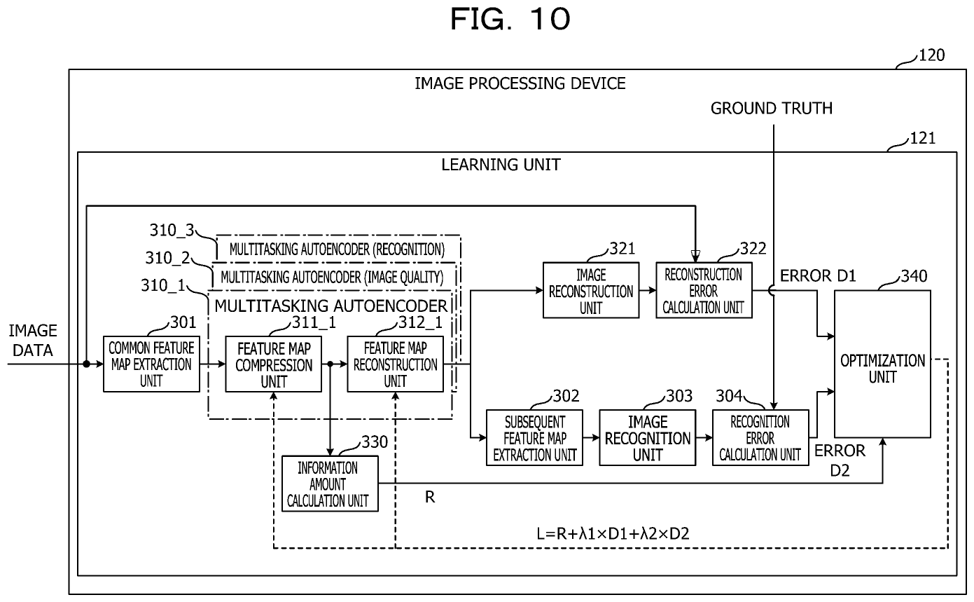

First, a functional configuration of an image processing device 120 according to the second embodiment in a learning phase will be described. FIG. 10 is a second diagram illustrating an example of a functional configuration of an image processing device in the learning phase. A difference from the functional configuration described with reference to FIG. 3 is that a learning unit 121 includes a plurality of multitasking autoencoders 310_1 to 310_3.

Of these, because the multitasking autoencoder 310_1 is similar to the multitasking autoencoder 310 described with reference to FIG. 3, description thereof will be omitted here.

On the other hand, the multitasking autoencoder 310_2 sets a value of the weighting coefficient λ1 to be larger than the value of the weighting coefficient λ1 that is used when the learning processing is executed for the multitasking autoencoder 310_1, when an optimization unit 340 calculates a cost L. As a result, a model parameter of the multitasking autoencoder 310_2 is updated through the learning processing that prioritizes the maintenance of the image quality.

Furthermore, the multitasking autoencoder 310_3 sets a value of the weighting coefficient λ2 to be larger than the value of the weighting coefficient λ2 that is used when the learning processing is executed for the multitasking autoencoder 310_1, when the optimization unit 340 calculates the cost L. As a result, the model parameter of the multitasking autoencoder 310_2 is updated through the learning processing that prioritizes the maintenance of the recognition accuracy.

Note that, in the example in FIG. 10, for convenience of explanation, the plurality of multitasking autoencoders 310_1 to 310_3 are illustrated. However, in terms of implementation, the single multitasking autoencoder 310 includes a plurality of types of different model parameter sets and performs switching to any one of the model parameter sets to be executed.

[Functional Configurations of Image Processing Device and Image Recognition Device in Inference Phase]

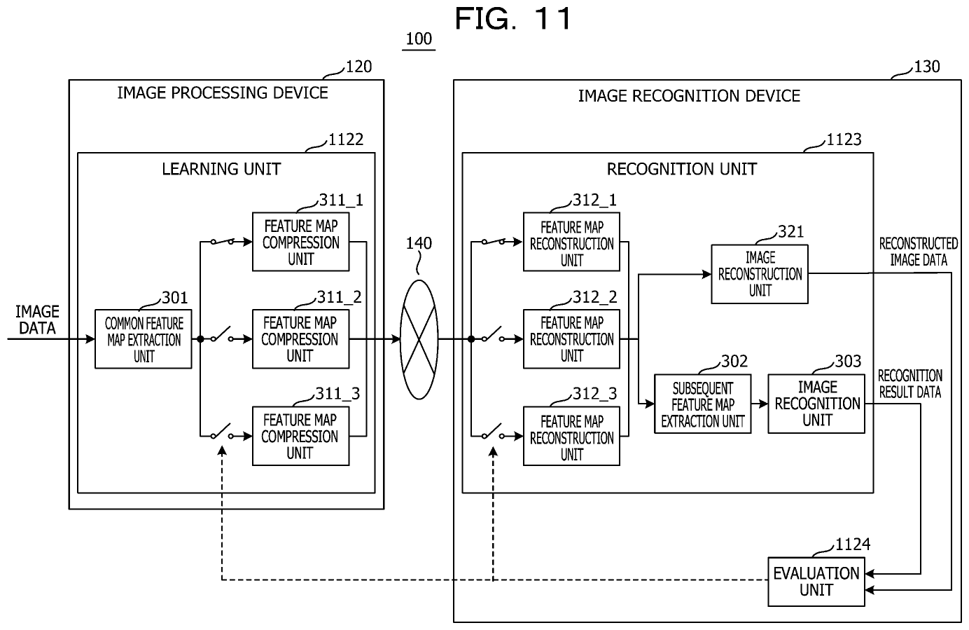

Next, functional configurations of the image processing device 120 and an image recognition device 130 according to the second embodiment in the inference phase will be described. FIG. 11 is a second diagram illustrating an example of functional configurations of the image processing device and the image recognition device in the inference phase. A difference from the functional configuration described with reference to FIG. 8 is that a compression unit 1122 includes a plurality of feature map compression units 311_1 to 311_3 and is connected to a common feature map extraction unit 301 via a changeover switch.

Furthermore, a difference from the functional configuration described with reference to FIG. 8 is that a recognition unit 1123 includes a plurality of feature map reconstruction units 312_1 to 312_3 and is connected to a network 140 via the changeover switch.

Furthermore, a difference from the functional configuration described with reference to FIG. 8 is that the recognition unit 1123 includes an evaluation unit 1124.

The evaluation unit 1124 evaluates an image quality of reconstructed image data output from an image reconstruction unit 321 and recognition accuracy of recognition result data output from an image recognition unit 303. Furthermore, in a case of evaluating that the image quality of the reconstructed image data is prioritized, the evaluation unit 1124 performs control to—turn OFF the changeover switch connected to the feature map compression unit 311_1, —turn ON the changeover switch connected to the feature map compression unit 311_2, —turn OFF the changeover switch connected to the feature map reconstruction unit 312_1, and turn ON the changeover switch connected to the feature map reconstruction unit 312_2.

Furthermore, in a case of evaluating that the recognition accuracy of the recognition result data is prioritized, the evaluation unit 1124 performs control to—turn OFF the changeover switch connected to the feature map compression unit 3111, —turn ON the changeover switch connected to the feature map compression unit 3113, —turn OFF the changeover switch connected to the feature map reconstruction unit 312_1, and—turn ON the changeover switch connected to the feature map reconstruction unit 312_3.

In this way, the evaluation unit 1124 evaluates which one of the image quality of the reconstructed image data and the recognition accuracy of the recognition result data is prioritized, and controls the changeover switch on the basis of the evaluation result.

As a result, for example, in a case where the image processing device 120 and the image recognition device 130 are applied to an abnormality detection system, the image processing device 120 and the image recognition device 130 operate as follows.

For example, in a case where no abnormality is detected in the abnormality detection system, the evaluation unit 1124 performs control to turn ON the changeover switches connected to the feature map compression unit 311_3 and the feature map reconstruction unit 312_3. As a result, the recognition unit 1123 easily detects an abnormality.

Furthermore, in a case where a large number of abnormalities are detected in the abnormality detection system, the evaluation unit 1124 performs control to turn ON the changeover switches connected to the feature map compression unit 311_2 and the feature map reconstruction unit 312_2. As a result, the recognition unit 1123 outputs reconstructed image data with a high image quality, and an inspector easily visually confirms the reconstructed image data, for the detected abnormality.

As is clear from the above description, the image recognition system 100 according to the second embodiment includes the plurality of feature map compression units that compresses the extracted feature map. Furthermore, the image recognition system 100 according to the second embodiment includes the plurality of feature map reconstruction units that reconstructs the compressed feature map. Furthermore, the image recognition system 100 according to the second embodiment includes the evaluation unit that evaluates the image quality of the reconstructed image data and the recognition accuracy of the recognition result and switches the plurality of feature map compression units and the plurality of feature map reconstruction units.

Then, in the image recognition system according to the second embodiment, the plurality of feature map compression units and the plurality of feature map reconstruction units are learned on the basis of the weighting coefficients different from each other.

In this way, the image recognition system 100 according to the second embodiment switches the feature map compression unit and the feature map reconstruction unit according to the evaluation of the image quality and the recognition accuracy. As a result, according to the second embodiment, it is possible to adjust the priority between the image quality and the recognition accuracy.

### Third Embodiment

In the first and second embodiments described above, it has been described as assuming that the multitasking autoencoder includes the single feature map compression unit and the single feature map reconstruction unit. However, the multitasking autoencoder is not limited to this, and for example, may include a single feature map compression unit and two feature map reconstruction units. As a result, even in a case where a feature map used to maintain an image quality is different from a feature map used to maintain recognition accuracy, it is possible to respectively reconstruct the corresponding feature maps. Hereinafter, a third embodiment will be described focusing on differences from the first and second embodiments described above.

[Functional Configuration of Image Processing Device in Learning Phase]

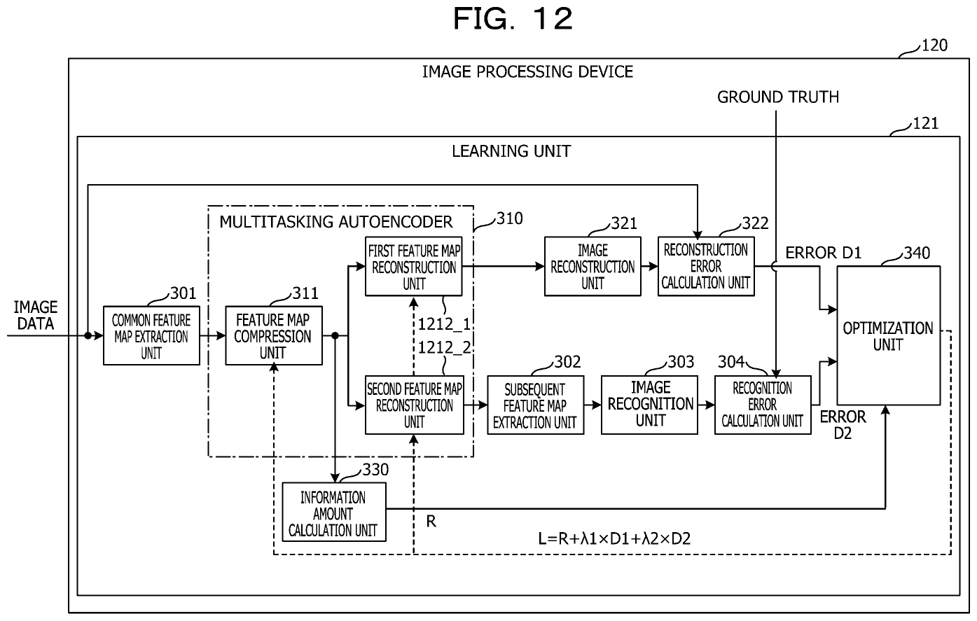

First, a functional configuration of an image processing device 120 according to a third embodiment in a learning phase will be described. FIG. 12 is a third diagram illustrating an example of a functional configuration of an image processing device in the learning phase. A difference from the functional configuration described with reference to FIG. 3 is that a multitasking autoencoder 310 of a learning unit 121 includes a first feature map reconstruction unit 1212_1 and a second feature map reconstruction unit 1212_2.

The first feature map reconstruction unit 1212_1 reconstructs a feature map compressed by a feature map compression unit 311 and notifies an image reconstruction unit 321 of the feature map. Note that, when learning processing by the learning unit 121 is executed, a model parameter of the first feature map reconstruction unit 12121 is appropriately updated so as to reconstruct a feature map that maintains an image quality of image data reconstructed by the image reconstruction unit 321.

The second feature map reconstruction unit 1212_2 reconstructs the feature map compressed by the feature map compression unit 311 and notifies a subsequent feature map extraction unit 302 of the feature map. Note that, when the learning processing by the learning unit 121 is executed, a model parameter of the second feature map reconstruction unit 1212_2 is appropriately updated so as to maintain recognition accuracy by an image recognition unit 303.

[Flow of Processing in Learning Phase]

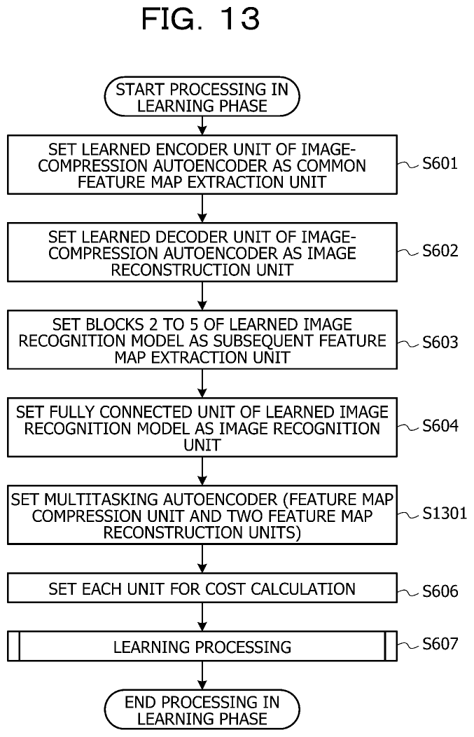

Next, a flow of processing of the entire image recognition system 100 in the learning phase will be described. FIG. 13 is a second flowchart illustrating the flow of the processing in the learning phase. A difference from the first flowchart described with reference to FIG. 6 is operation S1301.

In operation S1301, a user of the image processing device 120 sets the multitasking autoencoder 310 to the learning unit 121. The multitasking autoencoder 310 includes an encoder unit that functions as the feature map compression unit 311, a decoder unit that functions as the first feature map reconstruction unit 12121, and a decoder unit that functions as the second feature map reconstruction unit 1212_2.

[Functional Configurations of Image Processing Device and Image Recognition Device in Inference Phase]

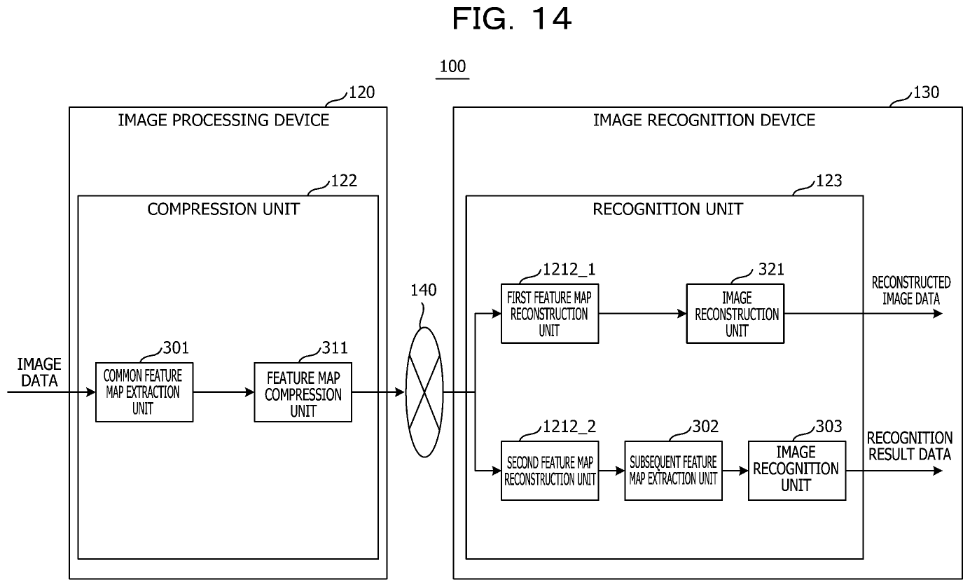

Next, functional configurations of the image processing device 120 and an image recognition device 130 according to the third embodiment in an inference phase will be described. FIG. 14 is a third diagram illustrating an example of functional configurations of the image processing device and the image recognition device in the inference phase.

Since a functional configuration of a compression unit 122 of the image processing device 120 among these is the same as the functional configuration of the compression unit 122 of the image processing device 120 described with reference to FIG. 8 in the first embodiment described above, description thereof will be omitted here.

On the other hand, among functional configurations of a recognition unit 123 of the image recognition device 130, a difference from the functional configurations of the recognition unit 123 of the image recognition device 130 described with reference to FIG. 8 in the first embodiment described above is the first feature map reconstruction unit 1212_1 and the second feature map reconstruction unit 1212_2.

The first feature map reconstruction unit 1212_1 is substantially the same as the first feature map reconstruction unit 1212_1 described with reference to FIG. 12. However, the first feature map reconstruction unit 1212_1 illustrated in FIG. 14 is a learned first feature map reconstruction unit of which a model parameter is updated through learning processing.

The second feature map reconstruction unit 1212_2 is substantially the same as the second feature map reconstruction unit 1212_2 described with reference to FIG. 12. However, the second feature map reconstruction unit 1212_2 illustrated in FIG. 14 is a learned second feature map reconstruction unit of which a model parameter is updated through learning processing.

[Effect of Having Two Feature Map Reconstruction Units]

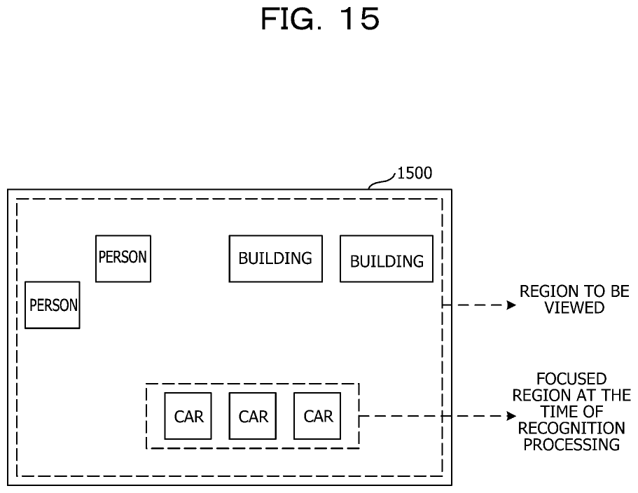

Next, an effect of having the first feature map reconstruction unit 1212_1 and the second feature map reconstruction unit 1212_2 by the recognition unit 123 of the image recognition device 130 will be described. FIG. 15 is a first diagram illustrating an example of reconstructed image data and illustrates image data 1500 for one frame.

It is assumed that the image data 1500 be used for visual monitoring and be used to detect traffic congestions. As illustrated in FIG. 15, the image data 1500 includes people, buildings, and cars. Although all of them are monitoring targets in the visual monitoring, cars are recognition targets in recognition processing for detecting traffic congestions.

In such a case, it is requested that an image quality of an entire frame be excellent as the reconstructed image data. The first feature map reconstruction unit 1212_1 needs to reconstruct a feature map used to achieve an excellent image quality. On the other hand, in order to achieve high recognition accuracy, the second feature map reconstruction unit 1212_2 needs to reconstruct a feature map important to recognition of cars in a car region.

In this way, in a case where a feature map needed to maintain an image quality is different from a feature map needed to maintain recognition accuracy, it is possible to improve the recognition accuracy of the recognition target while maintaining an image in an entire frame by arranging the two feature map reconstruction units so that the different feature maps may be reconstructed. Moreover, by arranging the two feature map reconstruction units, the feature map compression unit 311 increases a compression rate when the feature maps are compressed. As a result, in the third embodiment, an effect equal to or more than the first embodiment described above may be achieved, and in addition, it is possible to improve a compression performance.

### Fourth Embodiment

In the first to third embodiments described above, when the reconstruction error calculation unit 322 calculates the error (D1) between the image data and the reconstructed image data, the target has been an entire frame. On the other hand, in a fourth embodiment, a case will be described where an error (D1′) is calculated for a region to be recognized included in image data. Hereinafter, the fourth embodiment will be described focusing on differences from each embodiment described above.

[Functional Configuration of Image Processing Device in Learning Phase]

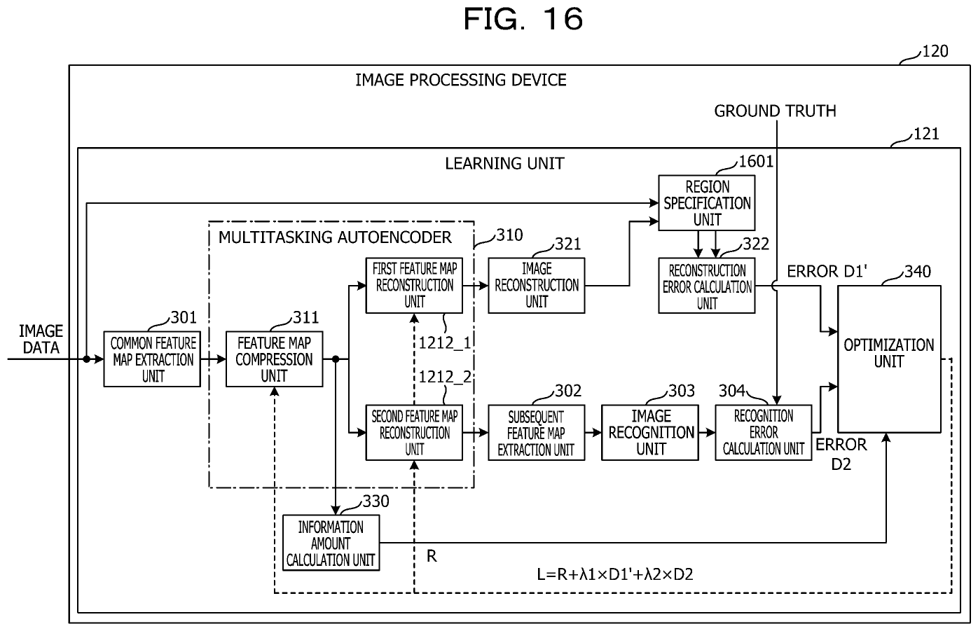

First, a functional configuration of an image processing device 120 according to the fourth embodiment in a learning phase will be described. FIG. 16 is a fourth diagram illustrating an example of a functional configuration of an image processing device in the learning phase. A difference from the functional configuration described with reference to FIG. 3 is that a learning unit 121 includes a region specification unit 1601.

The region specification unit 1601 specifies a region to be recognized included in the image data and notifies the reconstruction error calculation unit 322 of image data in the specified region. Furthermore, the region specification unit 1601 specifies a region to be recognized included in image data reconstructed by an image reconstruction unit 321 and notifies the reconstruction error calculation unit 322 of the reconstructed image data in the specified region.

As a result, the reconstruction error calculation unit 322 compares image data input to a common feature map extraction unit 301 with the reconstructed image data notified by the image reconstruction unit 321 regarding the region to be recognized and calculates the error (D1′).

[Flow of Learning Processing]

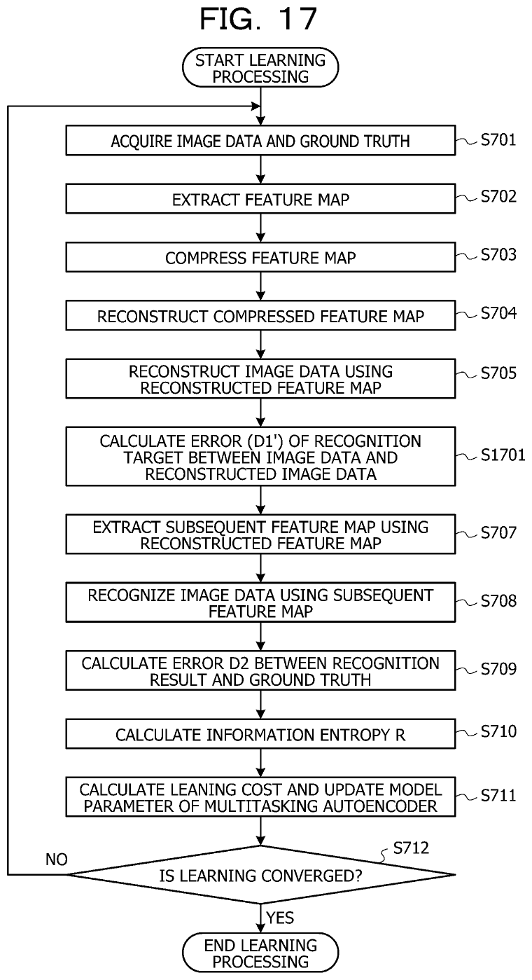

Next, details of learning processing (operation S607 in FIG. 6) by the image processing device 120 according to the fourth embodiment will be described. FIG. 17 is a second flowchart illustrating a flow of the learning processing. Note that a difference from the first flowchart described with reference to FIG. 7 is operation S1701.

In operation S1701, the region specification unit 1601 specifies a region to be recognized included in image data acquired by the learning unit 121. Furthermore, the region specification unit 1601 specifies a region to be recognized included in image data reconstructed by the image reconstruction unit 321. Moreover, the reconstruction error calculation unit 322 of the learning unit 121 compares the image data acquired by the learning unit 121 and the image data reconstructed by the image reconstruction unit 321 regarding the region to be recognized and calculates the error (D1′).

[Effect of Comparing Region to be Recognized and Calculating Reconstruction Error]

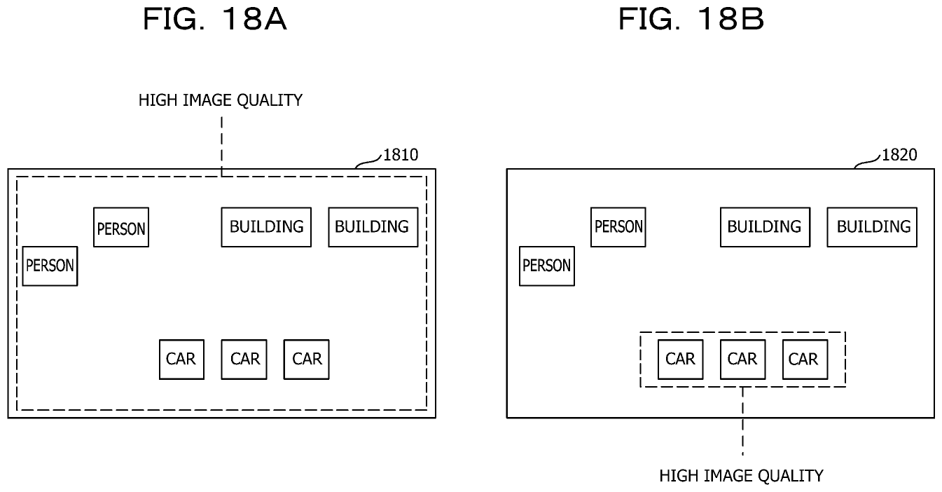

Next, an effect of comparing the image data and the reconstructed image data regarding the region to be recognized and calculating the error (D1′) by the reconstruction error calculation unit 322 will be described. FIGS. 18A and 18B are second diagrams illustrating an example of the reconstructed image data and illustrate image data 1810 for one frame and image data 1820 for one frame.

It is assumed that the image data 1810 and 1820 be used to detect a traffic congestion and be also used to visually confirm the traffic congestion when the traffic congestion is detected. As illustrated in FIGS. 18A and 18B, the image data 1810 and 1820 includes people, buildings, and cars. However, in recognition processing for detecting a traffic congestion, a car is a recognition target, and in visual confirmation of a traffic congestion, a car is a confirmation target.

In such a case, it is not needed that an image quality of the entire frame is necessarily excellent as the reconstructed image data, and it is sufficient that an image quality of a car region is excellent in a case where a traffic congestion is detected. For example, as illustrated in FIG. 18A, image data with a high image quality does not need to be reconstructed in the entire frame, and as illustrated in FIG. 18B, it is sufficient that image data of a car region to be recognized be reconstructed with a high image quality and image data of a region other than the car region be reconstructed with a low image quality.

In this way, the region specification unit 1601 is arranged in a case where only the region to be recognized needs an excellent image quality and the reconstruction error calculation unit 322 calculates the error in the region to be recognized so that the image data having the region to be recognized with a high image quality and the region other than the recognition target with a low image quality may be reconstructed. As a result, the feature map compression unit 311 improves a compression rate when the feature map for the region other than the recognition target is compressed. As a result, according to the fourth embodiment, an effect similar to the first embodiment described above may be achieved, and in addition, it is possible to improve a compression performance.

### OTHER EMBODIMENTS

In each of the embodiments described above, description has been made focusing on a point that both of the image quality and the recognition accuracy are achieved. However, the effects of each of the embodiments described above are not limited to this. For example, it is assumed that the learned encoder unit 401 that is caused to function as the common feature map extraction unit 301 be able to achieve a compression rate equivalent to that of an existing compression technique (for example, compression technique according to H.265 standard). In this case, the compression unit 122 in each of the embodiments described above further compresses the image data, which is compressed by the common feature map extraction unit 301, by using the feature map compression unit 311. For example, according to the compression unit 122 in each of the embodiments described above, it is possible to reliably achieve a compression rate higher than the existing compression techniques.

Furthermore, in each of the embodiments described above, description has been made focusing on a point that both of the image quality and the recognition accuracy are achieved. However, the effects of each of the embodiments described above are not limited to this. According to the compression unit 122 according to each of the embodiments described above, for example, a processing time may be shortened as compared with the existing compression techniques (for example, compression technique according to H.265 standard).

For example, in a case of the existing compression technique (for example, compression technique according to H.265 standard), a processing time of predetermined image data is about 30 to 100 msec. However, according to each of the embodiments described above, the processing time may be shortened to about one msec.

Furthermore, in each of the embodiments described above, a specific example of the image-compression autoencoder 400 has not been mentioned. However, the image-compression autoencoder 400 may be, for example, a convolutional auto encoder (CAE). Alternatively, the image-compression autoencoder 400 may be, for example, a variational auto encoder (VAE). Alternatively, the image-compression autoencoder 400 may be, for example, a recurrent neural network (RNN) or a generative adversarial network (GAN).

Furthermore, in each of the embodiments described above, a specific example of the learned image recognition model 500 has not been mentioned. However, the learned image recognition model 500 may be, for example, representative models of an image classification task VGG16 and ResNet50, a representative model of an object detection task YOLOv3, or the like.

Furthermore, in the second embodiment described above, a case has been described where the learning processing is executed on three combinations as combinations of the weighting coefficients (λ1 and λ2). However, it goes without saying that the number of combinations of the weighting coefficients (λ1 and λ2) is not limited to three and any number of combinations is possible.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image recognition system comprising:
at least a memory; and
at least a processor coupled to at least the memory, respectively, and configured to:
extract feature maps from an input image;
compress the extracted feature maps;
reconstruct the compressed feature maps;
reconstruct an image from the reconstructed feature maps and output the reconstructed image; and
recognize the input image based on the reconstructed feature maps and output a recognition result,
wherein the compressing the extracted feature maps and the reconstructing the compressed feature maps are learned so as to minimize a cost based on an information amount when compressing the extracted feature maps, a first error between the input image and the reconstructed image, and a second error between the recognition result and a ground truth.

2. The image recognition system according to claim 1, wherein
the reconstructing the compressed feature maps includes reconstructing a first feature map needed to maintain an image quality and reconstructing a second feature map needed to maintain recognition accuracy,
the reconstructing the compressed feature maps outputs the reconstructed image by reconstructing an image from the first feature map, and
the recognizing the input image recognizes the input image based on the second feature map and outputs a recognition result.

3. The image recognition system according to claim 2, wherein the compressing the extracted feature maps, the reconstructing the first feature map, and the reconstructing the second feature map are learned so as to minimize the cost based on the information amount when compressing the extracted feature maps, the first error, and the second error.

4. The image recognition system according to claim 1, wherein the first error when compressing the extracted feature maps and the reconstructing the compressed feature maps are learned is calculated for a region to be recognized.

5. The image recognition system according to claim 1, wherein the information amount when compressing the extracted feature maps is an information entropy of a probability distribution obtained by compressing the extracted feature maps.

6. The image recognition system according to claim 1, wherein
the recognizing the input image includes
extracting a third feature map used to recognize an image from the reconstructed feature maps, and
recognizing a recognition target included in the input image, based on the third feature map, and outputting the recognition target as the recognition result.

7. The image recognition system according to claim 1, wherein the compressing the extracted feature maps and the reconstructing the compressed feature maps have a plurality of types of sets of model parameters learned by changing a weighting coefficient when the cost is calculated, and any one of the sets of the model parameters to be executed is switched.

8. An image recognition method comprising:
extracting feature maps from an input image;
compressing the extracted feature maps;
reconstructing the compressed feature maps;
reconstructing an image from the reconstructed feature maps and outputting the reconstructed image; and
recognizing the input image based on the reconstructed feature maps and outputting a recognition result, by at least a processor,
wherein the compressing the extracted feature maps and the reconstructing the compressed feature maps are learned so as to minimize a cost based on an information amount when compressing the extracted feature maps, a first error between the input image and the reconstructed image, and a second error between the recognition result and a ground truth.

9. A learning device comprising:
a memory; and
a processor coupled to the memory and configured to:
extract a feature maps from an input image;
compress the extracted feature maps;
reconstruct the compressed feature maps;
reconstruct an image from the reconstructed feature maps and output the reconstructed image; and
recognize the input image based on the reconstructed feature maps and output a recognition result,
wherein the processor learns the compressing the extracted feature maps and the reconstructing the compressed feature maps so as to minimize a cost based on an information amount when compressing the extracted feature maps, a first error between the input image and the reconstructed image, and a second error between the recognition result and a ground truth.
